(19) United States
(12) Patent Application Publication
(10) Pub. No.: US 2001/0015967 A1
(43) Pub. Date: Aug. 23, 2001

(54) Wireless LAN system

(76) Inventor: Toshihiro Sugiura, Nisshin-shi (JP)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/784,516

(22) Filed: Feb. 15, 2001

(30) Foreign Application Priority Data
Feb. 16, 2000 (JP) 2000-38332

(51) Int. Cl. H04Q 7/24; H04J 1/00; H04L 12/56

(52) U.S. Cl. 370/338; 370/401; 370/485

(57) ABSTRACT

A LAN constituted over a pair of buildings, located a distance from each other, comprises hubs, a server and personal computers. In the LAN, a wired LAN including a wireless transmission section between the pair of buildings, and a wireless LAN including wireless access sections between an access point and wireless terminals are connected to each other. A transmission frequency band (5 GHz) used in the wireless transmission section and a transmission frequency band (2.4 GHz) used in the wireless access sections are set to be distinct from each other so that the deterioration of transmission quality by interference of electric waves used in both of the wireless sections can be securely prevented.

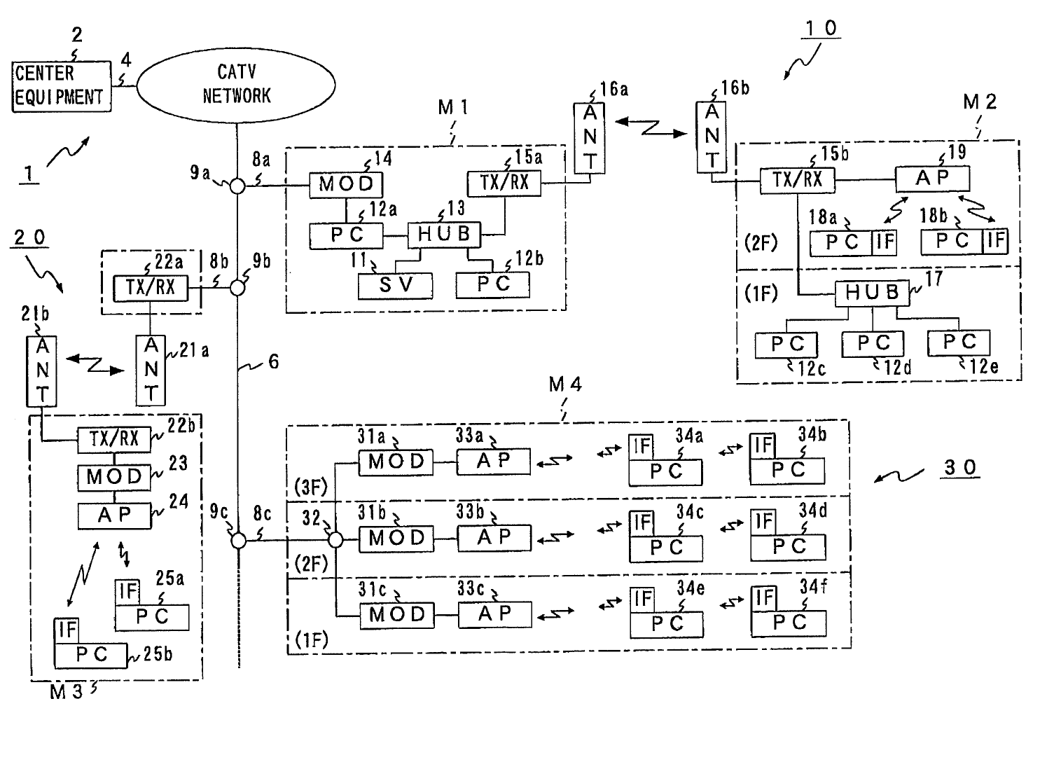

### BACKGROUND OF THE INVENTION

i) Technical Field of the Invention

This invention relates to a wireless LAN system to be connected to a bi-directional CATV system, comprising an access point capable of being accessed from wireless terminal.

ii) Description of the Related Art

Bi-directional CATV systems known in the art offer highly advanced service of transmitting upward signals directed to a center equipment from subscribers' terminals, as well as multiplexing downward signals of various broadcastings (such as TV broadcasting, teletext broadcasting, facsimile broadcasting and data broadcasting) directed to the subscribers' terminals from the center equipment. The center equipment of this bi-directional CATV system is connected to the Internet so that the system can provide the subscribers with low-price Internet connections, utilizing a bi-directional data transmission function specific to this system without using telephone lines. In recent years, for the purpose of connecting LANs (Local Area Networks) to the Internet, such bi-directional CATV systems are proposed to be utilized.

In the field of LANs, so-called wireless LAN systems are well-known, which enable terminals to access LANs by wireless, in order to get rid of irksome wiring between the terminals.

On the other hand, in the bi-directional CATV systems, it is necessary to provide transmission lines such as of coaxial cables or optic fibers between the center equipment and subscribers' residences. Accordingly, use of wireless transmission is proposed in the sections where it takes a lot of trouble to lay a new cable, such as through a broad river and road.

In case that a wireless LAN system is constituted to be connected to a bi-directional CATV system provided with such wireless transmission sections, wireless transmissions are conducted in both the outside wireless transmission sections and inside wireless access sections. Therefore, when the outside wireless transmission sections exist in the neighborhood of a building where access points are provided, there is a fear that interference may occur between the electric waves used in each of the wireless sections and transmission quality of the waves may be deteriorated.

### SUMMARY OF THE INVENTION

One object of the present invention is to provide a wireless LAN system to be connected to a bi-directional CATV system, having an access point capable of being accessed from wireless terminal, and in which system, deterioration in transmission quality in wireless sections is prevented.

In order to attain the above object, in a wireless LAN system of this invention connected to a bi-directional CATV system which comprises wireless transmission section for transmitting signals by wireless in transmission path from a center equipment of the bi-directional CATV system to an access point, a transmission frequency band in wireless access section between the access point and wireless terminal is set to be distinct from a transmission frequency band in the wireless transmission section.

According to the wireless LAN system of the present invention, no interference occurs between electric waves used in the wireless transmission section and in the wireless access section Also, the transmission quality in both wireless sections is not deteriorated by the electric waves in each other's wireless sections. As a result, high transmission quality in both of the wireless sections is achieved.

The present invention is preferably adopted even if the wireless transmission section is provided in the outside transmission path to the access point from a branching device for branching a lead-in wire from a transmission line of the bi-directional CATV system. In this case, both of the wireless sections are closely located and consequently the present invention can be effectively adopted.

Specifically, as the cases to which the present invention is adoptable, there are cases in that the transmission line of the bi-directional CATV system is not provided close to a building and a wireless transmission is adopted between a branching device and the building, or a wireless LAN is constructed over a plurality of buildings and transmissions between the buildings are conducted by wireless.

When such wireless LAN system is constituted, a bi-directional CATV system reserving both higher and lower frequency bands for transmitting upward signals directed to a center equipment from terminals than a frequency band for transmitting downward signals directed to the terminals from the center equipment can be utilized. In this case, the bi-directional CATV system can transmit larger amount of upward signals compared to a conventional bi-directional CATV system using only a higher frequency band for upward signals than a frequency band for downward signals. Thus, much more terminal connections can be made, and it is possible to constitute a relatively large wireless LAN system.

### BRIEF DESCRIPTION OF THE DRAWING

The invention will now be described, by way of example, with reference to the accompanying drawing, in which:

FIGURE is a block diagram showing a constitution of a wireless LAN system in an embodiment.

### DETAILED DESCRIPTION OF THE INVENTION

As shown in the single FIGURE, wireless LAN systems 10, 20, 30 of the present embodiment are respectively connected to a bi-directional CATV system 1. The bi-directional CATV system 1 is constituted as such that a transmission signal in a predetermined frequency band (for example, ranging from 54 to 722 MHz) is transmitted from a center equipment 2 to terminals as a downward signal, and an upward signal in a lower frequency band (for example, ranging from 5-42 MHz) than that of the downward signal as well as another upward signal in a higher frequency band (for example, ranging from 770-890 MHz) than that of the downward signal are respectively transmitted from the terminals to the center equipment 2.

The bi-directional CATV system 1 is provided with a main line 4 connected to the center equipment 2 as a transmission line to transmit signals bi-directionally between the center equipment 2 and subscribers' terminals of the system 1, a plurality of branch lines 6 branching from the main line 4, and subordinate branch lines 8 (8a, 8b, 8c) further branching from the branch lines 6 by means of branching devices 9 (9a, 9b, 9c) such as branch amplifiers, splitters and tap-offs.

In addition, the center equipment 2 is connected to the Internet (not shown), and the subscribers of the system 1 can utilize the Internet from their terminals via the center equipment 2.

Now, a description of a wireless LAN system 10 constructed over a pair of buildings M1, M2 located at a distance from one another is given.

In the wireless LAN system 10 of the building M1, a server 11 and personal computers 12a, 12b are connected in star connection via a hub 13. The personal computer 12a is connected to the subordinate branch line 8a, via a cable modem 14, drawn into the building M1 via the branching device 9a.

Specifically, terminal devices such as the server 11 and the personal computers 12 connected to the wireless LAN system 10 can be connected to the external bi-directional CATV system 1, and further to external information networks such as the Internet, via the personal computer 12a connected to the cable modem 14.

To the hub 13 is connected a wireless link 15a for demodulating a digital-modulated signal in a predetermined frequency band (of 5 GHz in the present embodiment) received via an antenna 16a and supplying it to the hub 13, as well as digital-modulating the data supplied from the hub 13 to a signal in the predetermined frequency band (of 5 GHz in the present embodiment) and transmitting it via the antenna 16a.

On the other hand, the building M2 is provided with an antenna 16b and a wireless link 15b similar to those provided in the building M1. These antennas 16a, 16b and wireless links 15a, 15b constitute a wireless line (hereinafter referred to as “wireless transmission section”) between the buildings M1 and M2.

The wireless link 15b and personal computers 12c, 12d, 12e are connected in star connection via a hub 17. Accordingly, the server 11 and the computers 12 (12a-12e) connected to the hubs 13, 17 constitute an independent wired LAN although it includes a wireless section in the transmission line.

In addition, to the wireless link 15b is connected an access point 19 for being accessed by wireless from the personal computers 18a, 18b hereinafter referred to as “wireless terminals”), to each of which an interface device being attached.

The access point 19 and the wireless terminals 18a, 18b constitute an independent wireless LAN, and the bridge function of the access point 19 makes it possible to connect this wireless LAN and the aforementioned wired LAN to each other. In a wireless line (hereinafter referred to as “wireless access section”) between the access point 19 and the wireless terminals 18, spread spectrum communications are performed using a signal in a predetermined transmission frequency band (of 2.4 GHz in the present embodiment).

As described in the above, in the wireless LAN system 10 according to the present embodiment, the wired LAN and the wireless LAN are connected to each other. In the wired LAN, there is further a wireless transmission section between the buildings M1 and M2, while in the wireless LAN, there are wireless access sections between the access point 19 and the wireless terminals 18.

However, a transmission frequency band (5 GHz) used for the wireless transmission section and a transmission frequency band used for the wireless access sections (2.4 GHz) are set to be distinct from each other.

Therefore, the wireless IAN system 10 of the present embodiment can prevent the deterioration of transmission quality caused by interference of electric waves used in both of the wireless sections to achieve reliable communications.

Now, a wireless LAN system 20 introduced in a general residential building M3 in the neighborhood of which the transmission line of the bi-directional CATV system 1 is not provided is described.

Instead of leading a transmission line of the bi-directional CATV system 1 into the residential building M3, a transmitter-receiver 22a is connected to the subordinate branch line 8b branching from the branching device 9b. The transmitter-receiver 22a is provided for up-converting a downward signal (in a frequency band ranging from 54 to 722 MHz) transmitted in the bi-directional CATV system 1 to a signal in a predetermined transmission frequency band (of 5 GHz in the present embodiment) and transmitting it via an antenna 21a, as well as down-converting an upward signal up-converted to a signal in the aforementioned predetermined transmission frequency band received via the antenna 21a to a signal in an original transmission frequency band (ranging from 5 to 42 MHz, from 770 to 890 MHz) and transmitting it to the subordinate branch line 8b.

On the other hand, the residential building M3 is provided with a cable modem 23 for transmitting and receiving data via the bi-directional CATV system 1 and also with a transmitter-receiver 22b. The transmitter-receiver 22b is for up-converting an upward signal outputted from the cable modem 23 to a signal in the aforementioned predetermined transmission frequency band to transmit via the antenna 21b as well as down-converting a downward signal up-converted to a signal in the aforementioned predetermined transmission frequency band received via the antenna 21b to a signal in a transmission frequency band (ranging from 54 to 722 MHz) specific to the bi-directional CATV system 1.

In other words, a part of a lead-in wire of the bi-directional CATV system 1 to which the wireless LAN system 20 is connected is constituted of a wireless line.

The residential building M3 is provided with an access point 24, and the access point 24 along with wireless terminals 25 (25a, 25b) constitutes a wireless LAN. The access point 24 is connected to the cable modem 23 so that each of the wireless terminals 25 can be connected to the bi-directional CATV system 1, and further to the external information networks such as the Internet via the wireless LAN.

The cable modem 23, access point 24 and wireless terminals 25 are constituted in the same way as the cable modem 14, access point 19 and wireless terminals 18 used in the aforementioned wireless LAN system 10.

In the wireless LAN system 20 constituted as such, a wireless LAN is constituted inside the building, and a wireless transmission line is provided outside the building. In addition, a transmission frequency band (2.4 GHz) in the wireless access section of the wireless LAN and a transmission frequency band (5 GHz) in the wireless transmission section of the lead-in wire (subordinate branch lines 8) are set to be distinct from each other.

Accordingly, the wireless IAN system 20 of the present embodiment, as well as the aforementioned wireless LAN system 10, can prevent the deterioration of transmission quality caused by interference of electric waves used in both of the wireless sections to achieve reliable communications.

Now, a wireless LAN system 30, arranged in the neighborhood of the wireless LAN systems 10, 20 including wireless transmission sections outside the buildings as above, is explained.

This wireless LAN system 30 is provided with cable modems 31 (31a, 31b, 31c) per each floor of a building M4. The subordinate branch line 8c, branched from the branching device 9c, is further branched at the splitter 32 to three directions. In each of the directions, it is connected to the cable modems 31a-31c, respectively.

Access points 33 (33a, 33b, 33c) are provided respectively in each floor, and these access points 33a-33c, along with a plurality of wireless terminals 34 (34a-34f) present on each floor, constitute a wireless LAN. They are connected to each of the cable modems 31a-31c on the same floor.

The cable modems 31, access points 33 and wireless terminals 34 are constituted in the same way as the cable modems 14, 23, access points 19, 24 and wireless terminals 18, 25 used in the above wireless LAN systems 10, 20.

Even though there are other wireless LAN systems including a wireless transmission line outside the building in the neighborhood, the wireless LAN system 30 constituted as such, as well as the wireless LAN systems 10, 20, can prevent the deterioration of transmission quality caused by interference of electric waves used in the wireless transmission line of the other LAN systems and the wireless access section between the access points 33 and the wireless terminals 34 to achieve reliable communications.

What is claimed is:

1. A wireless LAN system to be connected to a bi-directional CATV system, comprising an access point capable of being accessed from wireless terminal,
wherein the bi-directional CATV system comprises a wireless transmission section for transmitting signals by wireless in transmission path between a center equipment of the bi-directional CATV system and the access point,
and a transmission frequency band used for transmitting signals in the wireless access section between the access point and the wireless terminal, and a transmission frequency band used for transmitting signals in the wireless transmission section are set to be distinct from each other.

2. A wireless LAN system set forth in claim 1, wherein said wireless transmission section is provided in outside transmission path to said access point from a branching device for branching a lead-in wire from a transmission line of said bi-directional CATV system.

3. A wireless LAN system set forth in claim 1, wherein both higher and lower frequency bands than a frequency band for transmitting downward signal directed to said terminal from said center equipment are set for transmitting upward signal directed to said center equipment from said terminal in said bi-directional CATV system.
